(19) United States
(12) Patent Application Publication
(10) Pub. No.: US 2016/0291267 A1
(43) Pub. Date: Oct. 6, 2016

(54) COUPLING OF PHOTODETECTOR ARRAY TO OPTICAL DEMULTIPLEXER OUTPUTS WITH INDEX MATCHED MATERIAL

(71) Applicant: Applied Optoelectronics, Inc., Sugar Land, TX (US)

(72) Inventors: Jun Zheng, Missouri City, TX (US); I-Lung Ho, Sugar Land, TX (US); Yi Wang, Katy, TX (US)

(21) Appl. No.: 14/672,802

(22) Filed: Mar. 30, 2015

(51) Int. Cl. G02B 6/42; G02B 6/293

(52) U.S. Cl. CPC G02B 6/4212; G02B 6/2938; G02B 6/425; G02B 6/4274; G02B 6/29304

(57) ABSTRACT

A system is provided for improved coupling of photodetectors to optical demultiplexer outputs, for example an arrayed waveguide grating (AWG), using a refractive index matched material. In one embodiment, the system may include an optical demultiplexer including multiple optical outputs corresponding to multiple signal channels and a photodetector array including a plurality of photodiodes aligned with the multiple optical outputs. The system may also include an epoxy disposed within a gap between each of the photodiodes and each of the corresponding optical outputs of the optical demultiplexer. The epoxy may be configured to provide an index of refraction that is matched to the optical demultiplexer.

### TECHNICAL FIELD

The present disclosure relates to optical transceivers and more particularly, to improved coupling of photodetectors to optical demultiplexer outputs with a refractive index matched material.

### BACKGROUND INFORMATION

Optical communications networks, at one time, were generally “point to point” type networks including a transmitter and a receiver connected by an optical fiber. Such networks are relatively easy to construct but deploy many fibers to connect multiple users. As the number of subscribers connected to the network increases and the fiber count increases rapidly, deploying and managing many fibers becomes complex and expensive.

A passive optical network (PON) addresses this problem by using a single “trunk” fiber from a transmitting end of the network, such as an optical line terminal (OLT), to a remote branching point, which may be up to 20 km or more. One challenge in developing such a PON is utilizing the capacity in the trunk fiber efficiently in order to transmit the maximum possible amount of information on the trunk fiber. Fiber optic communications networks may increase the amount of information carried on a single optical fiber by multiplexing different optical signals on different wavelengths using wavelength division multiplexing (WDM). In a WDM-PON, for example, the single trunk fiber carries optical signals at multiple channel wavelengths to and from the optical branching point and the branching point provides a simple routing function by directing signals of different wavelengths to and from individual subscribers. In this case, each subscriber may be assigned one or more of the channel wavelengths on which to send and/or receive data.

To transmit and receive optical signals over multiple channel wavelengths, the OLT in a WDM-PON may include a multi-channel transmitter optical subassembly (TOSA), a multi-channel receiver optical subassembly (ROSA), and associated circuitry. In the ROSA, multiple photodiodes are optically coupled to multiple outputs from an optical demultiplexer, such as an arrayed waveguide grating (AWG), for receiving multiple optical signals over multiple channels.

One of the challenges in these WDM systems is to efficiently couple the photodiode array to the AWG to operate within a power budget where higher receiver sensitivity may be required. Existing systems typically use a lens assembly and/or decrease the spacing between the photodiode and the AWG output. These approaches, however, tend to be relatively more complicated and expensive and may require stricter tolerances and more complex alignment procedures.

### BRIEF DESCRIPTION OF THE DRAWINGS

These and other features and advantages will be better understood by reading the following detailed description, taken together with the drawings wherein:

FIG. 1 is a functional block diagram of a wavelength division multiplexed (WDM) passive optical network (PON) including at least one compact multi-channel optical transceiver, consistent with embodiments of the present disclosure.

FIG. 2 is an exploded view of a compact multi-channel optical transceiver including a multi-channel TOSA, ROSA and circuit board, consistent with an embodiment of the present disclosure.

FIG. 3 is a top view inside the compact multi-channel optical transceiver shown in FIG. 2.

FIG. 4 is an exploded perspective view of a multi-channel ROSA for use in a compact multi-channel optical transceiver, consistent with an embodiment of the present disclosure.

FIG. 5 is a cross-sectional view of the multi-channel ROSA shown in FIG. 4.

FIG. 6 is an enlarged, side perspective view of the array of photodetectors optically coupled to the respective optical outputs of the optical demultiplexer in the ROSA shown in FIG. 4.

FIG. 7 is a top view of an AWG coupled to an array of photodetectors.

FIG. 8 illustrates the effects of an air interface between an AWG and a photodetector.

FIG. 9 illustrates the effects of an index-matched interface between an AWG and a photodetector.

### DETAILED DESCRIPTION

A multi-channel receiver optical subassembly (ROSA), consistent with embodiments described herein, includes an optical demultiplexer, such as an arrayed waveguide grating (AWG), with outputs optically coupled to respective photodetectors such as photodiodes. In one embodiment, the system may include an optical demultiplexer including multiple optical outputs corresponding to multiple signal channels and a photodetector array including a plurality of photodiodes aligned with the multiple optical outputs. The system may also include an epoxy, or other suitable material, to serve as a coupling medium, disposed within a gap between each of the photodiodes and each of the corresponding optical outputs of the optical demultiplexer. The epoxy may be configured to provide an index of refraction that is matched to the optical demultiplexer to improve optical coupling to the photodiodes.

A compact multi-channel optical transceiver may include the multi-channel ROSA, and the optical transceiver may be used in a wavelength division multiplexed (WDM) optical system, for example, in an optical line terminal (OLT) in a WDM passive optical network (PON).

As used herein, “channel wavelengths” refer to the wavelengths associated with optical channels and may include a specified wavelength band around a center wavelength. In one example, the channel wavelengths may be defined by an International Telecommunication (ITU) standard such as the ITU-T dense wavelength division multiplexing (DWDM) grid. The term “coupled” as used herein refers to any connection, coupling, link or the like and “optically coupled” refers to coupling such that light from one element is imparted to another element.

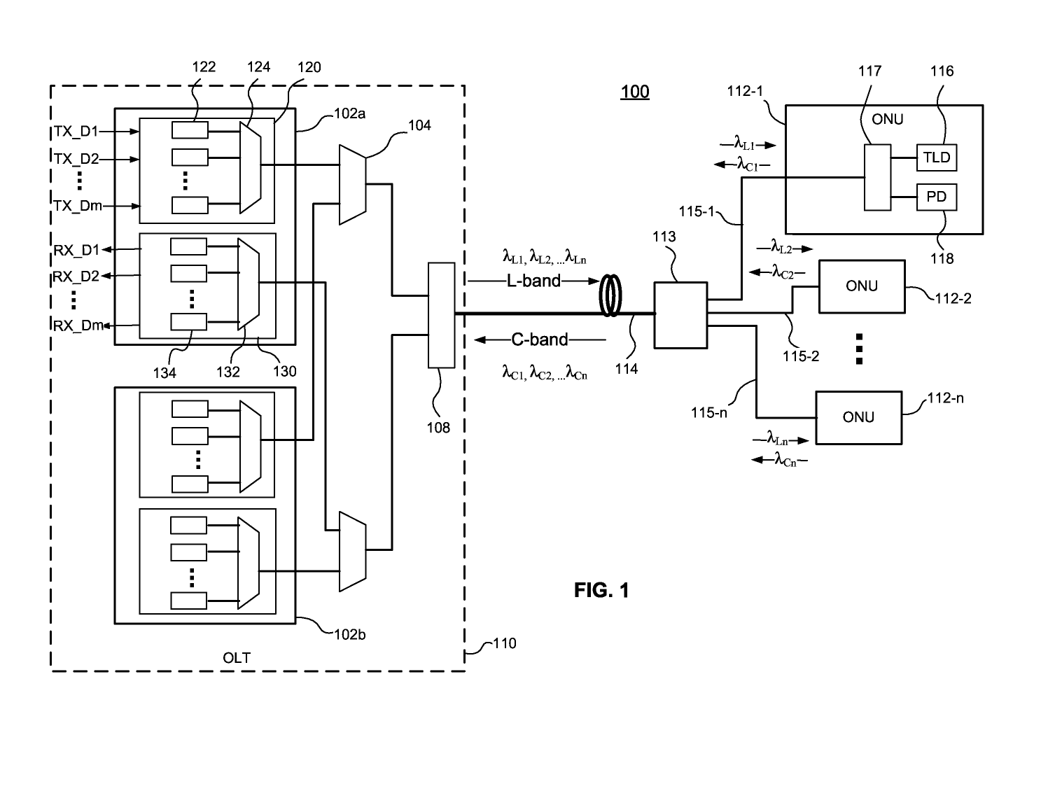

Referring to FIG. 1, a WDM-PON 100 including one or more multi-channel optical transceivers 102a, 102b, consistent with embodiments of the present disclosure, is shown and described. The WDM-PON 100 provides a point-to-multipoint optical network architecture using a WDM system. According to one embodiment of the WDM-PON 100, at least one optical line terminal (OLT) 110 may be coupled to a plurality of optical networking terminals (ONTs) or optical networking units (ONUs) 112-1 to 112-n via optical fibers, waveguides, and/or paths 114, 115-1 to 115-n. Although the OLT 110 includes two multi-channel optical transceivers 102a, 102b in the illustrated embodiment, the OLT 110 may include one or more multi-channel optical transceivers.

The OLT 110 may be located at a central office of the WDM-PON 100, and the ONUs 112-1 to 112-n may be located in homes, businesses or other types of subscriber location or premises. A branching point 113 (e.g., a remote node) couples a trunk optical path 114 to the separate optical paths 115-1 to 115-n to the ONUs 112-1 to 112-n at the respective subscriber locations. The branching point 113 may include one or more passive coupling devices such as a splitter or optical multiplexer/demultiplexer. In one example, the ONUs 112-1 to 112-n may be located about 20 km or less from the OLT 110.

In the WDM-PON 100, different ONUs 112-1 to 112-n may be assigned different channel wavelengths for transmitting and receiving optical signals. In one embodiment, the WDM-PON 100 may use different wavelength bands for transmission of downstream and upstream optical signals relative to the OLT 110 to avoid interference between the received signal and back reflected transmission signal on the same fiber. For example, the L-band (e.g., about 1565 to 1625 nm) may be used for downstream transmissions from the OLT 110 and the C-band (e.g., about 1530 to 1565 nm) may be used for upstream transmissions to the OLT 110. The upstream and/or downstream channel wavelengths may generally correspond to the ITU grid. In one example, the upstream wavelengths may be aligned with the 100 GHz ITU grid and the downstream wavelengths may be slightly offset from the 100 GHz ITU grid. The ONUs 112-1 to 112-n may thus be assigned different channel wavelengths within the L-band and within the C-band.

The branching point 113 may demultiplex a downstream WDM optical signal (e.g., λ^{L1}, λ^{L2}, . . . , λ^{Ln}) from the OLT 110 for transmission of the separate channel wavelengths to the respective ONUs 112-1 to 112-n. Alternatively, the branching point 113 may provide the downstream WDM optical signal to each of the ONUs 112-1 to 112-n and each of the ONUs 112-1 to 112-n separates and processes the assigned optical channel wavelength. The branching point 113 also combines or multiplexes the upstream optical signals from the respective ONUs 112-1 to 112-n for transmission as an upstream WDM optical signal (e.g., λ^{C1}, λ^{C2}, . . . , λ^{Cn}) over the trunk optical path 114 to the OLT 110.

One embodiment of the ONU 112-1 includes a laser 116, such as a laser diode, for transmitting an optical signal at the assigned upstream channel wavelength (λ^{C1}) and a photodetector 118, such as a photodiode, for receiving an optical signal at the assigned downstream channel wavelength (λ^{L1}). This embodiment of the ONU 112-1 may also include a diplexer 117 coupled to the laser 116 and the photodetector 118.

The OLT 110 may be configured to generate multiple optical signals at different channel wavelengths (e.g., λ^{L1}, λ^{L2}, . . . , λ^{Ln}) and to combine the optical signals into the downstream WDM optical signal carried on the trunk optical fiber or path 114. Each of the OLT multi-channel optical transceivers 102a, 102b may include a multi-channel transmitter optical subassembly (TOSA) 120 for generating and combining the optical signals at the multiple channel wavelengths. The OLT 110 may also be configured to separate optical signals at different channel wavelengths (e.g., λ^{C1}, λ^{C2}, . . . , λ^{Cn}) from an upstream WDM optical signal carried on the trunk path 114 and to receive the separated optical signals. Each of the OLT multi-channel optical transceivers 102a, 102b may thus include a multi-channel receiver optical subassembly (ROSA) 130 for separating and receiving the optical signals at multiple channel wavelengths. As will be described in greater detail below, the multi-channel TOSA 120 and ROSA 130 are configured and arranged to fit within a relatively small transceiver housing.

One embodiment of the multi-channel TOSA 120 includes an array of lasers 122, such as laser diodes, which may be modulated by respective RF data signals (TX_D1 to TX_Dm) to generate the respective optical signals. The lasers 122 may be modulated using various modulation techniques including external modulation and direct modulation. An optical multiplexer 124, such as an arrayed waveguide grating (AWG), combines the optical signals at the different respective downstream channel wavelengths (e.g., λ^{L1}, λ^{L2}, . . . , λ^{Ln}).

One embodiment of the multi-channel ROSA 130 includes a demultiplexer 132 for separating the respective upstream channel wavelengths (e.g., λ^{C1}, λ^{C2}, . . . , λ^{Cn}). An array of photodetectors 134, such as photodiodes, detects the optical signals at the respective separated upstream channel wavelengths and provides the received data signals (RX_D1 to RX_Dm). As described in greater detail below, the outputs of the demultiplexer 132 may be aligned with and optically coupled to the photodetectors 134, through a material or medium of matched refractive index, to provide a relatively high coupling efficiency. A diplexer 108 may be configured to couple the trunk optical path 114 to the OLT multi-channel optical transceivers 102a, 102b.

In one example, each of the multi-channel optical transceivers 102a, 102b may be configured to transmit and receive 16 channels such that the WDM-PON 100 supports 32 downstream L-band channel wavelengths and 32 upstream C-band channel wavelengths.

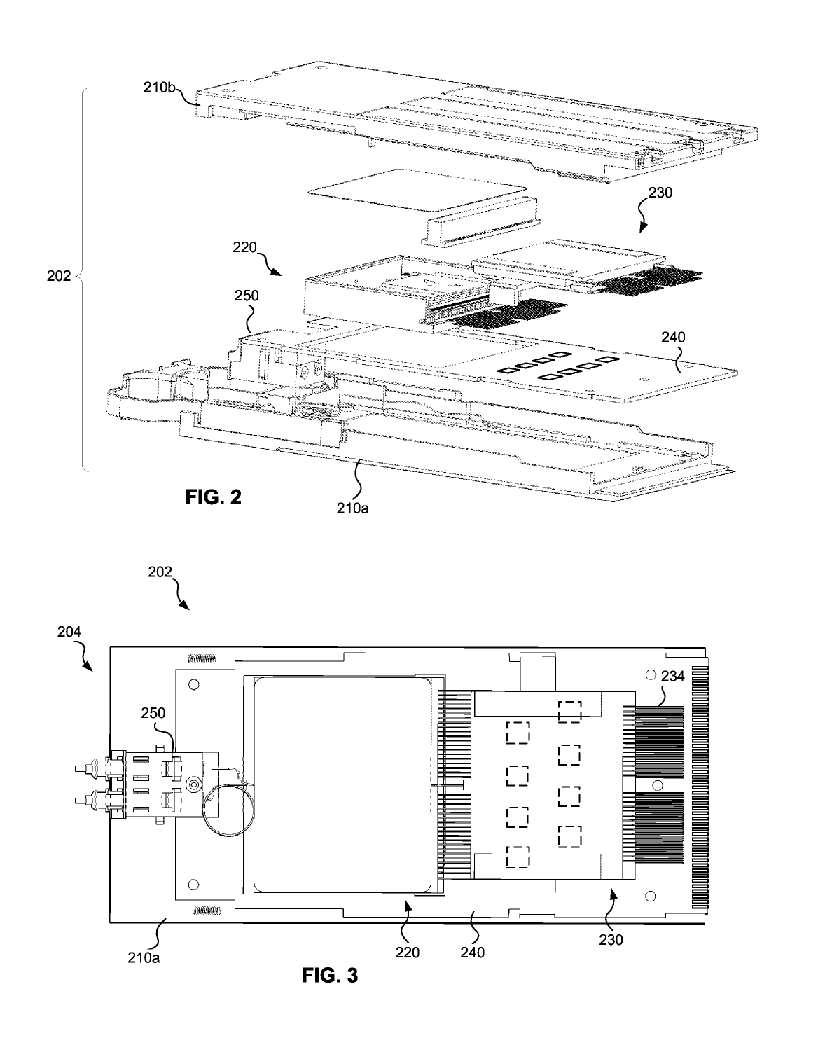

Referring to FIGS. 2 and 3, one embodiment of a compact multi-channel optical transceiver module 202 is shown and described in greater detail. As discussed above, multiple multi-channel transceiver modules may be used in an OLT of a WDM-PON to cover a desired channel range. The transceiver module 202 may thus be designed to have a relatively small form factor with minimal space. The compact optical transceiver module 202 generally provides an optical input and output at an optical connection end 204 and electrical input and output at an electrical connection end 206. The transceiver module 202 includes a transceiver housing 210a, 210b enclosing a multi-channel TOSA 220, a multi-channel ROSA 230, a circuit board 240, and a dual fiber adapter 250 directly linked to the TOSA 220 and the ROSA 230 for providing the optical input and output. The printed circuit board 240 may include circuitry and electronic components such as laser diode drivers, control interfaces, and temperature control circuitry.

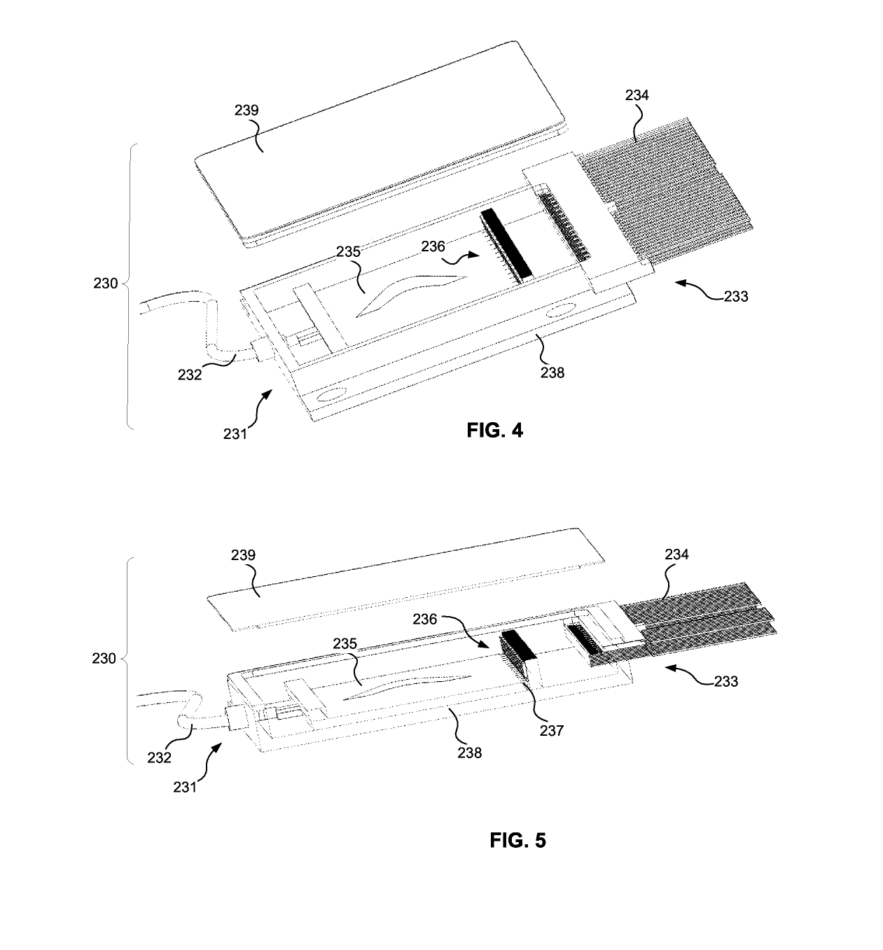

Referring to FIGS. 4 and 5, an embodiment of the multi-channel ROSA 230 is described in greater detail. The ROSA 230 includes a demultiplexer 235, such as an AWG, mounted on a ROSA base portion 238. Optical outputs 237 of the demultiplexer 235 are optically coupled to an array of photodetectors 236, such as photodiodes. An input of the demultiplexer 235 is optically coupled to the input optical fiber 232 at the optical connection end 231 and the output of the photodetectors 236 are electrically connected to the ROSA pins 234 at the electrical connection end 233. A ROSA cover 239 covers the ROSA base portion 238 and encloses the demultiplexer 235 and array of photodetectors 236.

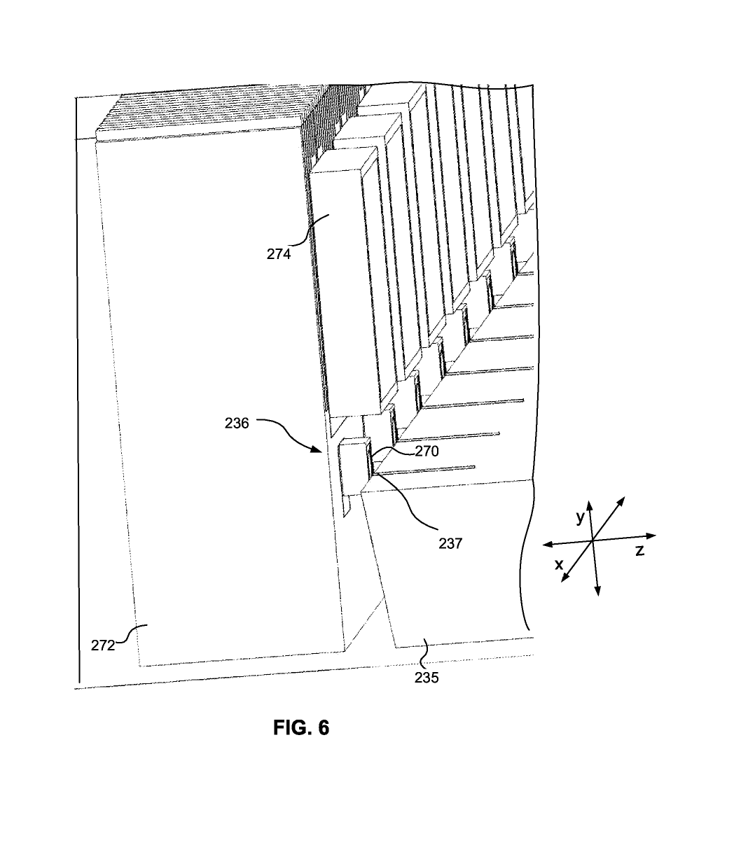

Referring to FIG. 6, optical coupling of the array of photodetectors 236 to the respective optical outputs 237 of the optical demultiplexer 235 is shown and described in greater detail. In the illustrated embodiment, the array of photodetectors 236 include photodiodes 270 which may be mounted on a photodetector mounting bar 272 together with associated transimpedance amplifiers (TIAs) 274. In one example, the photodiodes 270 are aligned with and spaced from (i.e., in the Z axis) the optical outputs 237 of the demultiplexer 235 in a range of 90-110 microns. In some embodiments, the spacing may be less than 50 micron. In the illustrated embodiment of a 16 channel ROSA, for example, 16 photodiodes 270 are aligned with 16 optical outputs 237 and electrically connected to 16 associated TIAs 274, respectively.

There is typically a design trade-off involved in the selection of the size of the photodiodes 270 (e.g., the surface area available to collect light from the optical outputs 237). A larger surface area may collect more light and operate more efficiently within the power budget, but will generally have a higher capacitance and therefore limit the frequency of the signal that can be detected.

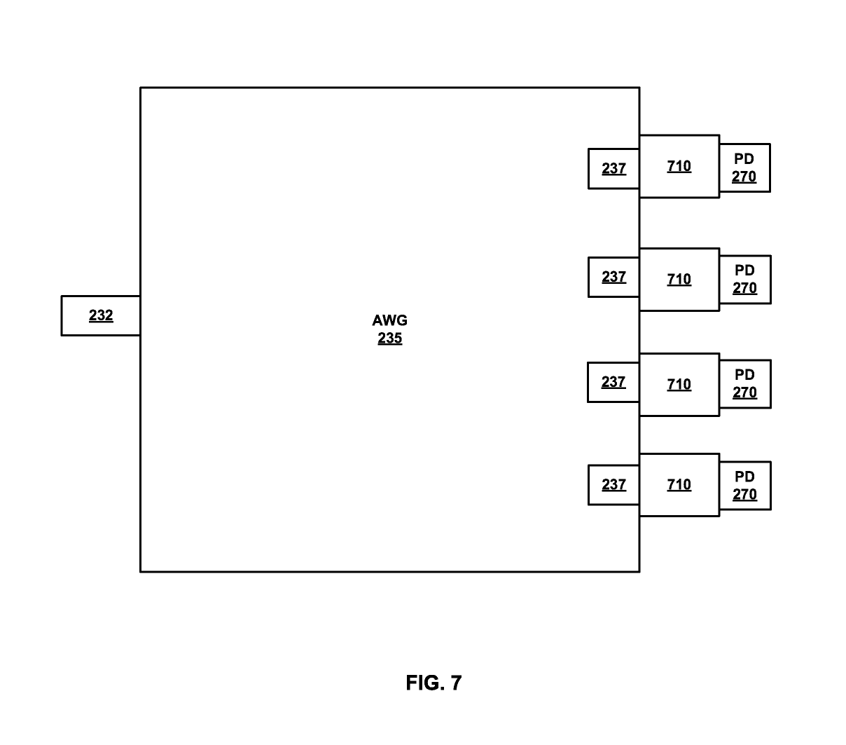

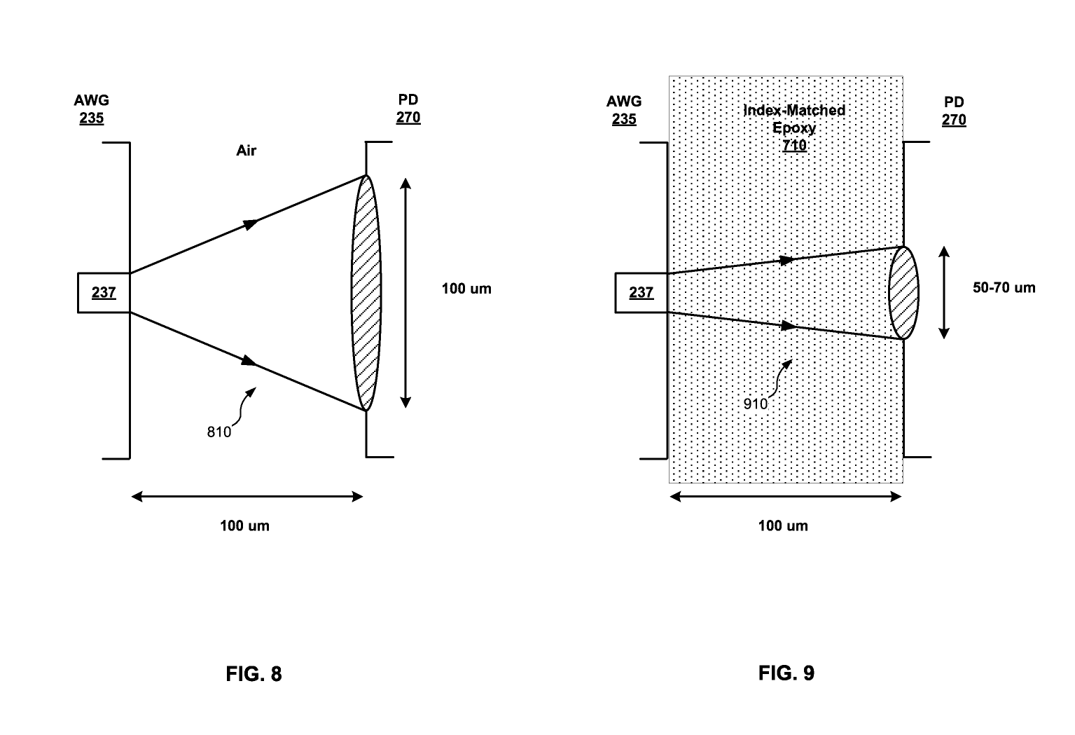

FIG. 7 illustrates a top view of the AWG 235 showing an epoxy 710 disposed between the optical outputs 237 and the photodiodes 270, in accordance with an embodiment of the present disclosure. The epoxy 710 is configured to provide an optical coupling between the outputs of the AWG and the photodiodes, with an index of refraction that is relatively close to that of the AWG 235. The distance between AWG 235 and photodetectors 236 may generally be less than 50 um and typically less than 30 um. In some embodiments, the epoxy may be Mercurium. By matching the index of refraction, the coupling efficiency may be increased and any back reflection (e.g., off of the receiving surface of the photodiode) may be decreased. This is explained below in connection with FIGS. 8 and 9, which illustrate the differences between an air interface and an index-matched epoxy interface, respectively. In some embodiments, the coupling efficiency may be increased to 95% or greater.

Referring to FIG. 8, the light 810 is shown projecting from the AWG optical output 237 onto the receiving surface of the photodiode 270 through an air interface or open gap between the AWG and the photodiode, which measures approximately 100 microns. The light can be seen to diverge at a relatively large angle, which may illuminate an area of approximately 100 micron diameter on the photodiode 270. This area may be undesirably large and unable to meet operational requirements due to the additional capacitance introduced by a larger photodiode or the loss of light signal that may be captured by a smaller photodiode. Although the operation may be improved by decreasing the distance between the AWG and the photodiode or by incorporating a lens to focus the light down to a smaller region, this would result in additional complication and expense and increase the difficulties associated with alignment. Instead, an embodiment of the present disclosure is illustrated in FIG. 9, where an epoxy is incorporated between the AWG 235 and the photodiode 270. An epoxy is selected with an index of refraction to more closely match that of the AWG. In some embodiments, the matched index of refraction of the epoxy may be within a range of about +/−10 percent of the index of refraction of the optical demultiplexer. In this example, the light emitted from the AWG optical output is seen to converge at a relatively smaller angle, which may illuminate a correspondingly smaller area on the photodiode 270, for example an area with a diameter in the range of 50 to 70 microns. In some embodiments, the angle of dispersion may improve from approximately 30 degrees to about 20 degrees.

It will be appreciated that the application of an epoxy between the AWG and the photodiode may be a simpler and less costly procedure than the insertion of a lens or lens assembly. For example, the epoxy may be injected into the gap between the AWG and the photodiode and left to cure. In some embodiments, the epoxy may be applied during the assembly process at approximately the same point at which epoxy is applied to bond the other side of the AWG 235 to the input optical fiber 232.

Accordingly, a multi-channel receiver optical subassembly (ROSA), consistent with embodiments described herein, provides improved coupling of photodetectors to optical demultiplexer outputs using a refractive index matched material as a coupling medium. The ROSA may include an optical demultiplexer including multiple optical outputs corresponding to multiple signal channels and a photodetector array including a plurality of photodiodes aligned with the multiple optical outputs. The ROSA may also include an epoxy disposed within a gap between each of the photodiodes and each of the corresponding optical outputs of the optical demultiplexer. The epoxy may be configured to provide an index of refraction that is matched to the optical demultiplexer.

Consistent with another embodiment, a method is provided for coupling photodiodes to optical outputs of an optical demultiplexer in a multi-channel receiver optical subassembly (ROSA). The method may include mounting the optical demultiplexer in a ROSA housing and positioning a photodetector array, comprising a plurality of the photodiodes, such that each of the photodiodes is aligned with a corresponding one of the optical outputs. The method may further include disposing an epoxy within a gap between each of the photodiodes and each of the corresponding optical outputs of the optical demultiplexer. The epoxy may be configured to provide an index of refraction matched to the optical demultiplexer.

While the principles of the invention have been described herein, it is to be understood by those skilled in the art that this description is made only by way of example and not as a limitation as to the scope of the invention. Other embodiments are contemplated within the scope of the present invention in addition to the exemplary embodiments shown and described herein.

Modifications and substitutions by one of ordinary skill in the art are considered to be within the scope of the present invention, which is not to be limited except by the following claims.

What is claimed is:

1. A multi-channel receiver optical subassembly (ROSA) comprising:
an optical demultiplexer comprising an arrayed waveguide grating (AWG) with multiple optical outputs corresponding to multiple signal channels;
a photodetector array comprising a plurality of photodiodes aligned with said multiple optical outputs; and
an epoxy disposed within a gap between each of said photodiodes and each of said corresponding optical outputs of said optical demultiplexer, said epoxy configured to provide an index of refraction matched to said optical demultiplexer, wherein said epoxy directly optically couples said optical outputs of said arrayed waveguide grating to said photodiodes, respectively.

2. The multi-channel ROSA of claim 1, wherein said matched index of refraction of said epoxy is within a range of +/−10 percent of an index of refraction of said optical demultiplexer.

3. The multi-channel ROSA of claim 1, wherein said matched index of refraction of said epoxy provides a coupling efficiency of 95% or higher between said photodetectors and said optical outputs of said optical demultiplexer.

4. (canceled)

5. The multi-channel ROSA of claim 1, wherein a distance between said photodiode and said corresponding optical output of said optical demultiplexer is less than 50 microns.

6. The multi-channel ROSA of claim 1, wherein said plurality of photodiodes are arranged on a photodetector mounting bar at a spacing that corresponds to a spacing of said optical outputs of said optical demultiplexer.

7. The multi-channel ROSA of claim 6, further comprising a plurality of transimpedance amplifiers (TIAs) disposed on said photodetector mounting bar, each of said TIAs electrically coupled to a respective one of said plurality of photodiodes.

8. (canceled)

9. The multi-channel ROSA of claim 1, wherein said optical demultiplexer comprises 16 of said optical outputs corresponding to 16 of said signal channels and said photodetector array comprises 16 photodiodes.

10. A method for coupling photodiodes to optical outputs of an optical demultiplexer in a multi-channel receiver optical subassembly (ROSA), the method comprising:
mounting said optical demultiplexer in a ROSA housing, wherein said optical demultiplexer comprises an arrayed waveguide grating (AWG) with said optical outputs;
positioning a photodetector array, comprising a plurality of said photodiodes, such that said each of said photodiodes is aligned with a corresponding one of said optical outputs; and
disposing an epoxy within a gap between each of said photodiodes and each of said corresponding optical outputs of said optical demultiplexer, said epoxy configured to provide an index of refraction matched to said optical demultiplexer, wherein said epoxy directly optically couples said optical outputs of said arrayed waveguide grating to said photodiodes, respectively.

11. The method of claim 10, wherein said matched index of refraction of said epoxy is within a range of +/−10 percent of an index of refraction of said optical demultiplexer.

12. The method of claim 10, wherein said matched index of refraction of said epoxy provides a coupling efficiency of 95% or higher between said photodetectors and said optical outputs of said optical demultiplexer.

13. (canceled)

14. The method of claim 10, wherein a distance between said photodiode and said corresponding optical output of said optical demultiplexer is less than 50 microns.

15. The method of claim 10, further comprising arranging said plurality of photodiodes on a photodetector mounting bar at a spacing that corresponds to a spacing of said optical outputs of said optical demultiplexer.

16. The method of claim 15, further comprising disposing a plurality of transimpedance amplifiers (TIAs) on said photodetector mounting bar and electrically coupling each of said TIAs to a respective one of said plurality of photodiodes.

17. (canceled)

18. The method of claim 10, wherein said optical demultiplexer comprises 16 of said optical outputs corresponding to 16 of said signal channels and said photodetector array comprises 16 photodiodes.

19. The multi-channel ROSA of claim 1, wherein a spacing between the optical outputs and the photodiodes and the index of refraction of the epoxy are configured such that light emitted from the optical outputs illuminates areas on the photodiodes, respectively, within an area having a diameter in the range of 50 to 70 microns.

20. The method of claim 10, wherein a spacing between the optical outputs and the photodiodes and the index of refraction of the epoxy are configured such that light emitted from the optical outputs illuminates areas on the photodiodes, respectively, having a diameter in the range of 50 to 70 microns.
